(19) United States
(12) Patent Application Publication
(10) Pub. No.: US 2017/0220358 A1
(43) Pub. Date: Aug. 3, 2017

(54) IDENTIFICATION AND PRESENTATION OF ELEMENT AT A FIRST DEVICE TO CONTROL A SECOND DEVICE

(71) Applicant: Lenovo (Singapore) Pte. Ltd., New Tech Park (SG)

(72) Inventors: Russell Speight VanBlon, Raleigh, NC (US); Arnold S. Weksler, Raleigh, NC (US); John Carl Mese, Cary, NC (US); Nathan J. Peterson, Oxford, NC (US)

(21) Appl. No.: 15/013,046

(22) Filed: Feb. 2, 2016

(51) Int. Cl. G06F 9/44; G06F 3/0481; H04N 21/41; G06F 3/0482; H04L 12/24; H04N 21/436; H04L 12/861; G06F 3/0484

(52) U.S. Cl. CPC G06F 9/4443; H04L 49/9068; G06F 3/04817; G06F 3/04847; G06F 3/0482; H04L 41/22; H04N 21/43615; H04N 21/4131

(57) ABSTRACT

In one aspect, a first device includes a processor, a display accessible to the processor, and storage accessible to the processor. The storage bears instructions executable by the processor to determine at least one element to present on the display to control a second device, where the determination is based at least in part on identification of at least one current relevancy parameter. The instructions are also executable by the processor to present the at least one element on the display.

### FIELD

The present application relates generally to identification and presentation of an element at a first device to control a second device.

### BACKGROUND

As recognized herein, users may control smart devices in their home from another device such as their smart phone. However, as also recognized herein, often times too many controls are presented, leading to confusion and frustration on the part of the user, or the user must go through multiple steps using their smart phone to arrive at the control they wish to use. There are currently no adequate solutions to the foregoing.

### SUMMARY

Accordingly, in one aspect a first device includes a processor, a display accessible to the processor, and storage accessible to the processor. The storage bears instructions executable by the processor to determine at least one element to present on the display to control a second device, where the determination is based at least in part on identification of at least one current relevancy parameter. The instructions are also executable by the processor to present the at least one element on the display.

In another aspect, a method includes identifying at least one selector to present on a display of a first device to control a second device based at least in part on identification of at least one criterion associated with a user being met, and presenting the selector on the display.

In still another aspect, a first device includes a first processor, network adapter, and storage bearing instructions executable by a second processor of a second device for determining at least one element to present on a display to control a third device, where the determining is based at least in part on identification of one or more of a current location of the second device, a current time of day, a current day, and at least one item to be addressed before an event transpires. The instructions are also executable by the second processor for presenting the at least one element on the display. The first processor transfers the instructions to the second processor over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart of an example algorithm in accordance with present principles;

FIG. 4 shows an example data table for use in accordance with present principles;

FIG. 5 is an example illustration in accordance with present principles; and

FIGS. 6-8 show example user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, in a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/of combined together in a single module and/or made available in a shareable library.

Logic when implemented in software, can be written in an appropriate language such as but not limited to C# or C++, and can be stored on or transmitted through a computer readable storage medium (e.g., that is not a transitory signal) such as a random access memory (RAM), read-only memory (ROM), electrically erasable programmable read-only memory (EEPROM), compact disk read-only memory (CD-ROM) of other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

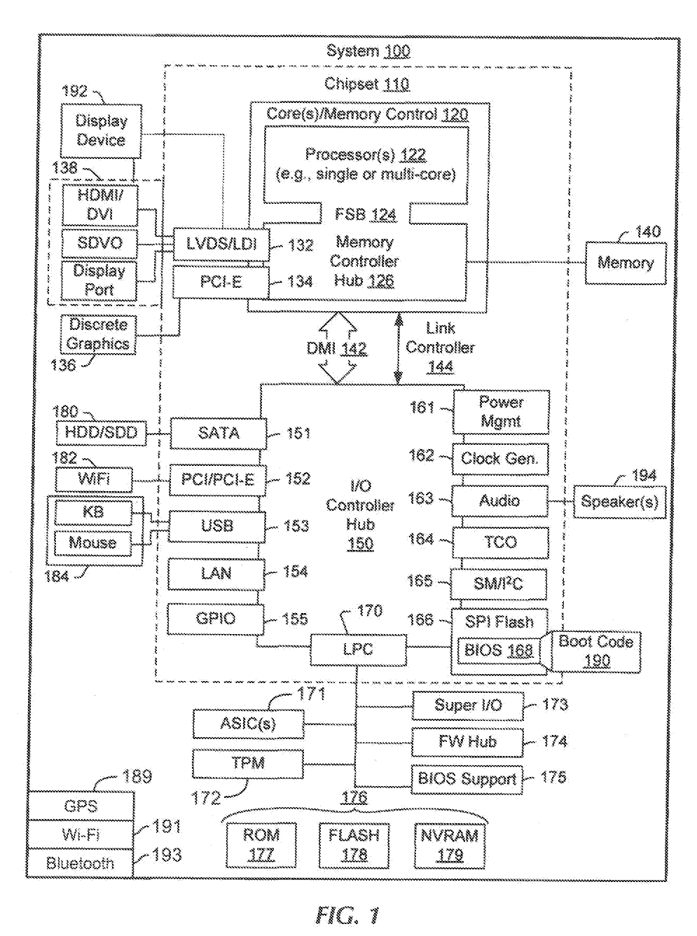

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g. data, signals, commands, etc.) via, for example, a direct management interface or direct media interface (DMI) 142 or a link controller 144. In the example of FIG. 1, the DMI 42 is a chip-to-chip interface (sometimes referred to as being a link between a “northbridge” and a “southbridge”).

The core and memory control group 120 include one or more processors 122 (e.g., single core or multi-core, etc.) and a memory controller hub 26 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI -E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit. Ethernet controller lines multiplexed with a PCI-E interface port. Other network features may operate independent of is PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, hut in any case the drives 180 are understood to be, e.g., tangible computer readable storage mediums that are not transitory signals. The hub controller 50 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, TPM may be capable of performing platform authentication and may be used to verify that a system seeking access is the expected system.

The system 100, upon power on, may be configured to execute hoot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, in some embodiments the system 100 may include a GPS transceiver 189 that is configured to receive geographic position information from at least one satellite and provide the information to the processor 122. However, it is to be understood that another suitable position receiver other than a GPS receiver may be used in accordance with present principles to determine the location of the system 100. FIG. 1 also shows that the system 100 may include a wireless local area network (WLAN) and/or Wi-Fi transceiver 191 for communicating with other devices in accordance with present principles using WLAN and/or Wi-Fi communication protocols, as well as a Bluetooth and/or Bluetooth low energy (BLE) communication element 193 (e.g., a Bluetooth 4.0 communication element) for communicating with other devices in accordance with the present principles using Bluetooth communication protocols.

Additionally, though now shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 132, an audio receiver/microphone that provides input to the processor 122 based on audio that is detected, such as via a user providing audible input to the microphone, and a camera that gathers one or more images and provides input related thereto to the processor 123. The camera may be a thermal imaging camera, a digital camera such as a webcam, a three-dimensional (3D) camera, and/or a camera otherwise integrated the system 100 and controllable by the processor 122 to gather pictures/images and/or video.

it is to be understood that an example client device or other machine/computer may include fewer or more features than shown on the system 100 of FIG. 1. In any case, it is to be understood at least based on the foregoing that the system 100 configured to undertake present principles.

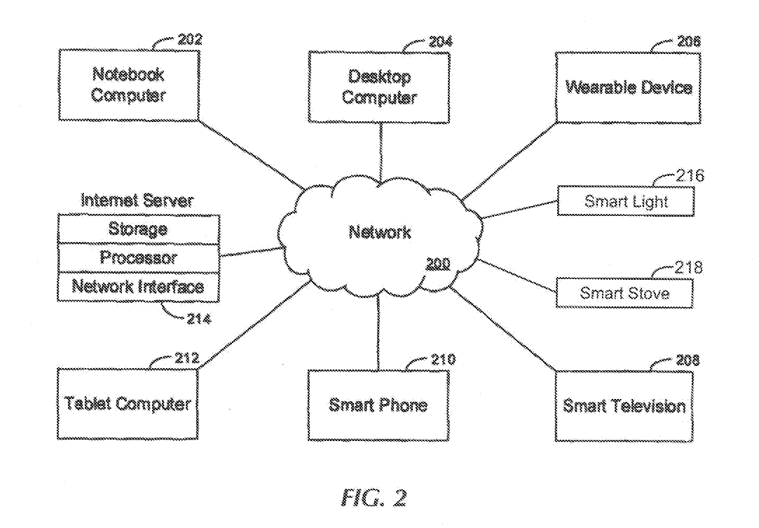

Turning now to FIG. 2, example devices are shown communicating over a network 200 such as the Internet in accordance with present principles. It is to be understood that each of the devices described in reference to FIG. 2 may include at least some of the features, components, and or elements of the system 100 described above.

FIG. 2 shows a notebook computer and/or convertible computer 202, a desktop computer 204, a wearable device 206 such as a smart watch, a smart television (TV) 208. a smart phone 210, a tablet computer 212, a server 214 such as an Internet server that may provide cloud storage accessible to the devices 202-212, and one or more other smart devices such as the smart light 216 and smart stove 218, both of which may be considered “smart appliances” and/or network communication-enabled appliances in accordance with present principles. It is to be understood that the devices 202-218 are configured to communicate with each other over the network 200 to undertake present principles.

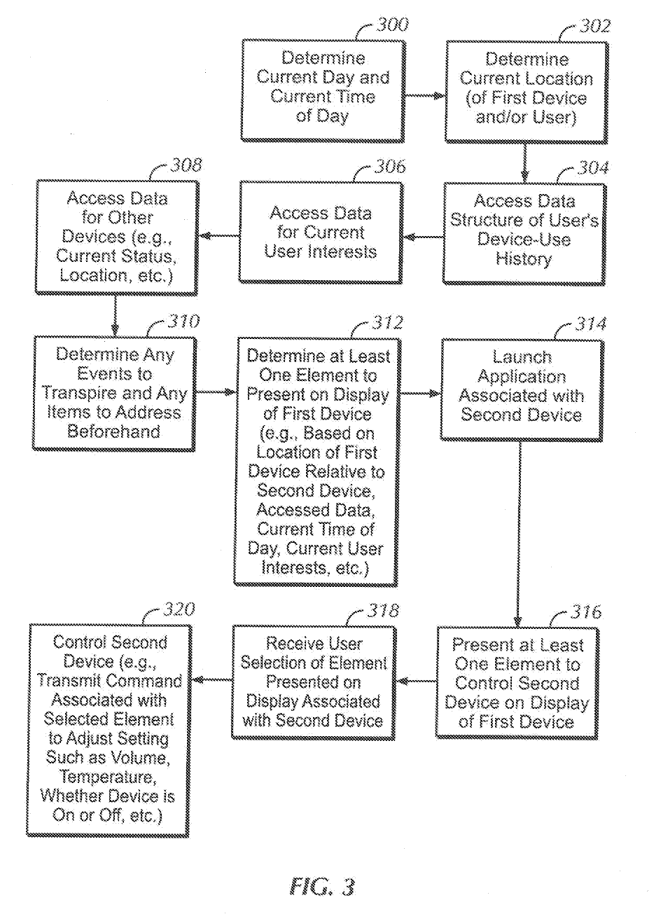

Referring to FIG. 3, it shows example logic that may be executed by a device such as the system 100 in accordance with present principles (referred to when describing FIG. 3 as the “first device”). Beginning at block 300, the logic may determine a current day (e.g., day of the week, day of the month, day of the year) and a current time of day. The logic may do so by accessing a clock application executing in the first device to identify data therefrom indicative of the current day and current time. The logic may also do so by accessing a resource over the Internet indicating a day and time, as well as by accessing a calendar application indicating a day and a time, in addition to other ways. The current day and/or current time may then be used by the first device to determine the current relevancy of certain items, and hence to determine one or more elements or selectors to present on the first device's display at block 312 (as will be discussed further below), such as based on a certain class of smart device-based activities or a certain class of other devices being associated in a data structure accessible to the first device with the particular day and/or time. For example, during a two-hour span associated with dinner meals from 6:00 p.m. to 8:00 p.m. as identified from a data structure, the first device may determine that selectors or elements for controlling a stove to cook food are currently relevant and hence present those elements/selectors at the first device. Front block 300 the logic may next proceed to block 303.

At block 302 the logic may determine a current location of the first device and/or a current location of the user (such as when the user is engaged with or holding the first device). The logic may determine a current location of the first device and/or user based on data from a GPS transceiver on the first device indicating GPS coordinates for the first device, based on data from a Wi-Fi Bluetooth transceiver on the first device that may be used to determine a strength of signals from various Wi-Fi or Bluetooth access points (e.g., having known locations) to determine as distance of the first device from the various access points and hence a location of the first device relative to the various access points (using, for example, received a signal strength indication (RSSI) algorithm). The current location of the first device and/or user may also based on data from a Wi-Fi Bluetooth transceiver on the first device that may be used to identify signals from one or more Bluetooth access points and then execute signal time of flight and/or angle of arrival algorithms, trilateration algorithms (such as when the location of the access points are known), and/or triangulation principles and algorithms, etc. to determine the location of the first device and/or user.

As another example for determining the location of the first device and/or user based on data from a Bluetooth transceiver on the first device, the Bluetooth transceiver may communicate with various Bluetooth beacons that the Bluetooth transceiver comes within signal range of as the first device changes location. These Bluetooth beacons may be broadcasting information pertaining to the location of the beacon and/or the area within the signal range of the beacon, and thus this information may be received by the Bluetooth transceiver and used by the first device to identify the location of the first device and/or user as various Bluetooth beacons come within range.

Still further, in some embodiments data from an accelerometer on the first device that is indicative of movement or non-movement may be processed using a dead reckoning algorithm to determine if the first device (and hence user) is moving and in which direction (e.g., relative to a known or previous location), which in turn may be used to determine the location of the first device based on the movement of it.

As another example data from a microphone and/or camera on the first device may be used to determine the location of the first device and/or user using a sound recognition algorithm (for data from the microphone) and using an object recognition algorithm (for data from the camera). For instance, the logic may determine the location of the first device based on sounds or objects recognized based on data from the microphone and camera, respectively, to the identify a predetermined location associated with the sound or object.

However, regardless of how determined, note that the current location may then be used by the first device to determine the current relevancy of certain items, and hence to determine one or more elements or selectors to present on the first device's display at block 312, such as based on a certain class of smart device-based activities or a certain class of other devices being associated in a data structure accessible to the first device with the current location or a predetermined area including the current location (e.g., a room in a house, or an area established by a threshold radius from a current location of the first device). For example, and activity such as turning a smart light in a particular room on or off may be determined to be currently relevant based on the first device being identified as currently associated with (e.g., located in) that room, and hence on and off selectors for turning the light on and off, respectively, may be determined at block 312 to be presented at the first device to control the smart light responsive to the first device being determined to be located in the room containing the smart light.

As another example, a class of devices, such as cooking-related smart devices in a user's home (e.g., a stove), may be determined to be currently relevant based on such a cooking-related smart device being identified as powered on and based on the first device being identified as more than a threshold distance from the cooking related smart device (such as if the user is driving away from their home), and hence an off selector for powering off the cooking-related smart device may be determined at block 312 to be presented at the first device responsive to the first device being determined to be located more than the threshold distance from the home.

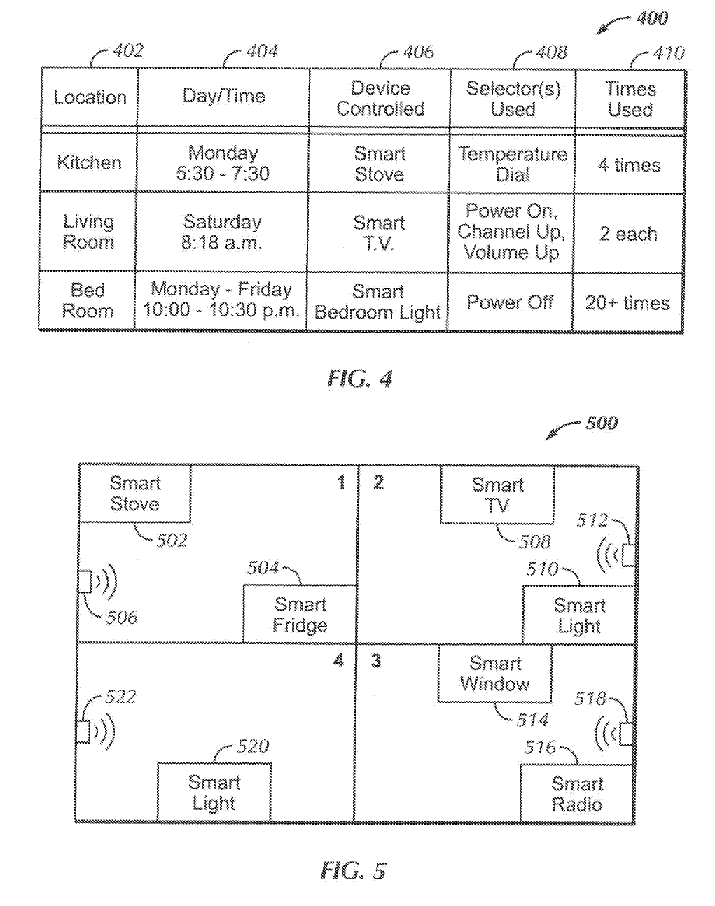

Still in reference to FIG. 3, from block 302 the logic may proceed next to block 304. At block 304 the logic may access one or more data structures (such as a data table like the one shown in FIG. 4) which may be stored at the first device or another device and establishes a history of the user's use of the first device, and/or other devices, control still other devices (such as smart appliances) in accordance with present principles. The data structure may be accessed to determine (at block 312) one or more currently relevant elements or selectors to present on a display of the first device to control another device based on a previous use of the element(s)/selector(s) at, for example, the same time of day and/or day of the week as the current time of day and/or day of the week, and/or at the same location as the current location of the first device or user. Note that the data structure may be populated and/or have entries added by the first device as the user continues to use the first device (and/or another computing device) to select dements to control various smart appliances, for example. An example of such a data structure will be discussed below in reference to FIG. 4.

From block 304 the logic may move to block 306. At block 306 the logic may access data pertaining to a user's current interests (such as sports T.V. shows, fiction e-books, a particular type of music, etc.), which may be stored at the first device or another device accessible to the first device, where the data may have been generated and stored based on user input specifying one or more current interests, based on interests identified by the first device from a profile associated with the user (such as a social networking profile), based on the device dynamically determining the users current interests based on a user's Internet browser history, based on applications or application types stored at the first device and used by the user, based on other data stored at the first device, etc. Thus, in some embodiments these current interests may be used to at least in part determine (at block 312) one or more elements or selectors to present on a display of the first device to control another device based on whether those selectors and/or other devices control things related to or associated with one or more of the user's current interests.

As may be appreciated from FIG. 3, after block 306 the logic may next move to block 108. At block 308 the logic may access data pertaining to other devices than are controllable using the first device, such as another smart device (e.g., a smart appliance). The data may be accessed via communication with the other device and/or a computer maintaining state information for the other device (such as a server or cloud storage area), and may pertain to a current status of the other device (such as if it is activated, what actions it is currently performing, a location at which it is located, etc.). This too may be used to at least in part determine (at block 312) one or more elements or selectors to present on a display of the first device to control the other device as will be discussed further below.

After block 308 the logic may proceed to block 310. At block 310 the logic may determine any events that are to transpire and any currently outstanding items that are to be addressed before the event(s) transpires. For example, at block 310 the logic may access the user's electronic calendar to identify an upcoming event (and even a location of the event), and the logic may determine based on a history accessible to the first device that a user typically performs a certain action (e.g., at a certain time of day, day of the week, and/or location) before an event of the same type as the upcoming event transpires. In addition to or in lieu of the foregoing, the logic may also identify, based on one or more predetermined parameters or criterion, one or more statuses of other devices controllable by the first device that may need to be adjusted before an event of a particular event type is to transpire.

Thus, e.g., the logic may identify in a particular instance that a user is about to go to sleep at a particular time of night based on the user previously going to sleep on past days of the same type (such as a weekday) within a certain time frame including the particular time of the current day at least a threshold amount of times (where sleep, or the transition to sleep from being awake, may be detected based on user inactivity with the first device for a threshold or prolonged period of time, and/or based on biometric sensors measuring biometrics of the user indicative of the user being asleep or transitioning sleep). The logic may also identify, based on one or more predetermined parameters, that a particular current status type for a particular class of devices, such as a cooking-related smart device being powered on, is to be indicated on the first device to the user prior to the user going to sleep so that the user may address the issue (such as by using an element or selector determined at block 312 and presented on the first device at block 316 to adjust a setting of the cooking-related smart device by powering it off).

Reference is now made to the aforementioned block 312, which may be arrived at after block 310. At block 312, the logic determines at least one element or selector to present on a touch-enabled display on the first device (and/or another display controllable by the first device) to control a second device based on one or more of the determinations and/or data that is accessed as discussed above in reference to blocks 300-310 and/or as otherwise discussed herein. Note that the logic may do so automatically without receipt of user input directed to an icon presented on the display of the first device to launch an application stored at the first device that is useable to control the second device.

From block 312 the logic of FIG. 3 may then move to block 314, where the logic may launch an application associated with controlling the second device from the first device in response to the determination(s) made at block (rather than receipt of user input directed to the icon referenced above), and then at block 316 (e.g., using the launched application) the logic may present at least one selector or element on the first device's display to control the second device (such as to adjust a setting of the second device like adjusting a temperature of a smart stove that is powered on).

From block 316 the logic may then proceed to block 318 where the logic may receive a user's selection of the element or selector (e.g., by detecting touch input to an area of the display presenting the element or selector), and in response the logic may move to block 320 where the logic may control the second device accordingly. For example, if one or more selectors for controlling, the volume of audio from the second device are presented on the first device's display at block 316 and one of those selectors is identified as selected at block 318, at block 320 the logic may transmit a command to the second device to adjust a volume setting for the second device up or down. As another example, if one or more selectors for controlling a cooking temperature for the second device (such as if the second device were a smart oven) are presented on the first device's display at block 316 and one of those selectors is identified as selected at block 318, at block 320 the logic may transmit a command to the second device to adjust a cooking temperature for the second device up or down.

Continuing the detailed description in reference to FIG. 4, it shows an example data table 400 that may be used in accordance with present principles to determine one or more elements or selectors to present on a display of a first device to control a second network communication-enabled device based on one or more current relevancy parameters and/or criteria such as a current location of the first device, a current day, and current time of day. Thus, a first column 402 contains data for various horizontal entries related to certain locations, a second column 404 contains data for the various entries related to certain days and certain times, and column 406 contains data for the various entries related to devices controlled at those respective locations, days, and/or times. Further, column 408 contains data for the various entries related to selectors respectively associated with the devices noted in column 405 that have been or are to be used at the respective locations, days, and/or times, while column 410 contains data for the various entries related to a number of times the respective selectors noted in column 408 have been used at the respective locations, days, and/or times.

Thus, as an example, if a first device undertaking present principles (such as executing the logic of FIG. 3) identified that it is currently located in the kitchen of a user's home, the first device may access the table 400 and parse the data in column 402 until an entry is located for the kitchen location, which in this case is the first horizontal entry shown. The logic may then move over to column 406 to identify a second device for which to launch an associated application and present a corresponding selector while the first device is located in the kitchen, in this case a smart stove, and then move to column 408 for the entry to identify a particular selector to present, which in this case is a temperature dial for adjusting a temperature of the smart stove.

As another example, if a first device undertaking present principles identified that it is currently 10:15 p.m. on a weekday, the first device may access the table 400, go to column 404 and parse the data therein until an entry is located that matches the time 10:15 p.m. for a weekday, which in this case is a weekday time range (10:00 p.m. to 10:30 p.m.) within which 10:15 p.m. fails as shown in the third-from-the-top horizontal entry. The logic may then move over to column 406 to identity a second device for which to launch an associated application and present a corresponding selector based on the current time, in this case a smart bedroom light, and then move to column 408 for the entry to identify a particular selector to present, which in this case is an off selector for turning oft the smart bedroom light.

Still in reference to FIG. 4, note that in some embodiments, each condition in columns 402 and 404 may have to be met for a given entry for the first device to then determine that a certain selector noted in the entry should be presented, while in other embodiments merely one of the conditions may be met as described above in the two examples above to then determine that a certain selector to present. Also note that the data table 400 may be continually updated by the first device as the user controls the first device to command various other devices by creating and/or updating corresponding entries in the data table 400 based on which smart device applications the user launches at certain locations and certain times/days, which other smart devices the user commands at certain locations and certain times/days, which selectors for those devices the user selects at certain locations and certain times/days, and how many times the user has done so at the certain locations and certain times/days (which may be noted in a column 410). Thus, it is to be understood that in some embodiments, another device that is controlled and/or a selector that is selected may have to be controlled or selected a threshold number of times before the first device automatically determines that it is to be presented based on one of the conditions noted in columns 402 and 404 being met and/or matched, while in other embodiments no such threshold may apply.

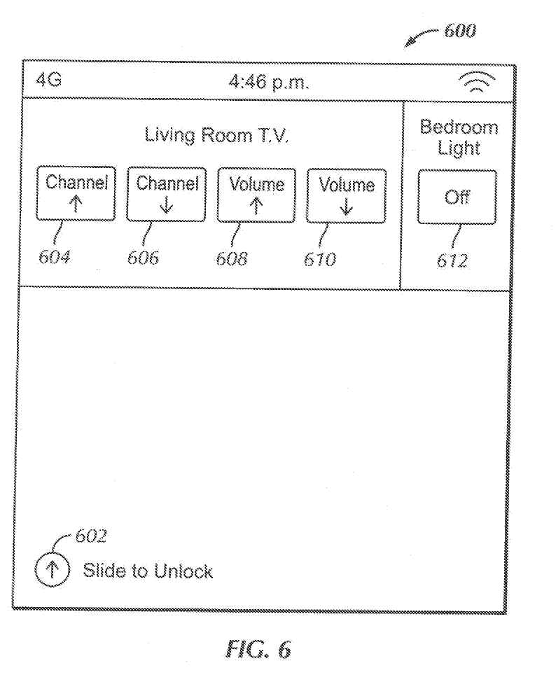

Now in reference to FIG. 5, it shows an example illustration 500 of a block diagram, map, or floor plan of a home containing one or more network communication-enabled devices that may communicate with and be controlled by a first device in accordance with present principles, such as a device executing the logic of FIG. 3. As may be appreciated from FIG. 5, Room 1 is a kitchen that contains a smart stove 502 and a smart fridge 504. Room. 1 also contains a wireless communication access point 506 that may be a Wi-Fi access point, or Bluetooth beacon from which signals may be received by the first device while within range of the access point 506 for determining a location of the first device in accordance with present principles, such as while within Room 1 if the access point 506 has been configured to transmit signals therein but not extending into other rooms of the home.

As may also be appreciated from FIG. 5, Room 2 is a living room that contains a smart television 508, a smart light 510, and a wireless communication access point 512 that may be a Wi-Fi access point or Bluetooth beacon from which signals may be received by the first device while within range of the access point 512 for determining a location of the first device in accordance with present principles. Room 3 is a restroom that contents a smart window 514, a small radio 516, and a wireless communication access point 518 that may be similar to the access points 506 and 512, mutatis mutandis. Room 4 is a bedroom that contains a smart light 520 and a wireless communication access point 522 that may be similar to the others, mutatis mutandis.

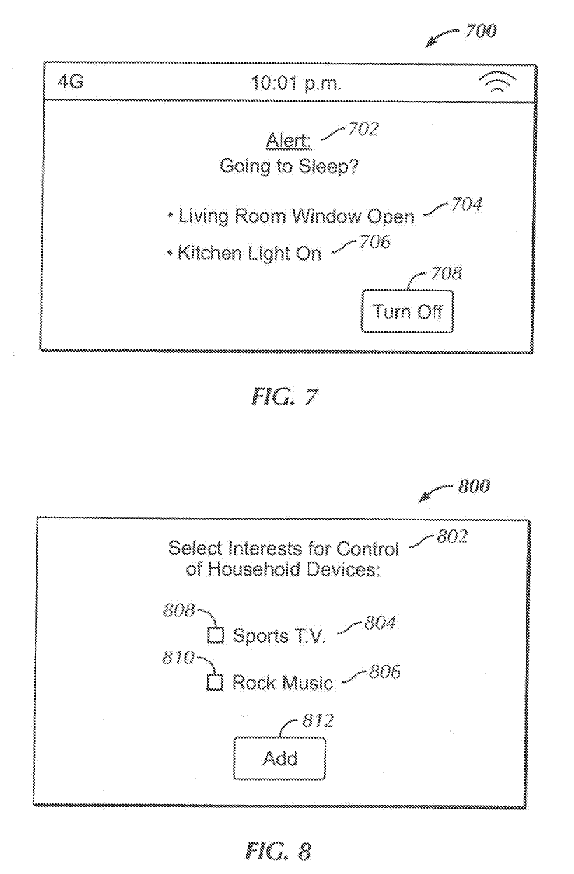

Moving on, reference is now made to FIG. 6, which shows an example user interface (UI) 600 presentable on a display of a device undertaking present principles, such as a device executing the logic of FIG. 3. The UI 600 is understood to be a lock screen UI, which may be a UI that is presented when a display of the device is activated but before access to various kinds of data and applications is provided (such as may be provided response is a user sliding the slider 602), and/or before a user logs in to the device and/or or is authenticated.

In an case, as may be appreciated from FIG. 6, the UI 600 may include one or more selectors 604-612 determined by a device presenting the UI 600 to be currently relevant based on one or more parameters or criterion as discussed herein. In the example shown, selectors 604 and 606 are respectively selectable for changing channels up and down on a smart television (TV) in a living room area, while selectors 608 and 610 are respectively selectable for turning the volume output of the smart TV up and down. A selector 612 is also shown that is selectable to turn a smart light off that is located in a bedroom of the same premises.

FIG. 7 shows another example UI 700, this one pertaining to at least one item to be addressed by a user before an event transpires. As may be appreciated from the UI 700, an alert 702 is presented asking if a user is going to sleep. The alert 702 also lists a first item 704 to be addressed bet we the user goes to sleep, which in this case is an open window in the user's living room that the user may wish to close before going to sleep, where the window includes circuitry to enable it to communicate with the device presenting the UI 700. The alert 702 also lists a second item 706 to be addressed before the user goes to sleep, which is that a kitchen light is activated. Because in this example the kitchen light may be controlled from the user's device, an element 708 is presented that is selectable to automatically deactivate the light without the user having to walk to the kitchen to turn it off at the light itself. Before moving on, it is to be understood in reference to FIG. 7 that the UI 700 may be presented automatically without user input responsive to a determination that the user is about to go to sleep and/or that the item(s) is to be addressed.

Continuing the detailed description in reference to FIG. 8, it shows yet another example 800 presentable on the display of a device undertaking present principles. The UI 800 includes a prompt 802 far a user to select one or more interests 804, 806 via respective check boxes 808, 810 for controlling one or more devices and/or presenting associated selectors based on the selected interests. In the example shown, listed interests include sports television and rock music. The UI 800 also includes an element 812 that is selectable to add another interest to the UI 800 (e.g., from a drop-down entered by the user using a keyboard) that may then be selected in accordance with present principles.

Providing an example of how a user s current interests and/or interest levels in particular topics may be used in accordance with present principles, suppose a user, while holding a device executing the logic discussed herein, walks into the family room of a home that includes a TV that is powered on and presenting content. The device may determine based on the user's stored interests and metadata pertaining to the content that is accessible to the device that the user is not interested in the content. Responsive to this determination, the device may present music player-related selectors on the devices lock screen to control musical content that may be presented via the TV that is of interest to the user.

Moving on from FIG. 8, it is to be understood that a UI may also be presented on a first device configured to undertake present principles for configuring one or more settings related to present principles. For example, the UI may contain one or more options for configuring the first device to present various selectors or controls respectively associated with respective smart devices accessible to the first device based on the first device being located at a particular location, based on a particular time of day, based on a particular day, based on items that should be addressed before another event specified by the user is to transpire, etc. This UI may also contain options for establishing the predetermined areas and thresholds discussed herein, and items for which a user should be altered after traveling a threshold distance from a given smart device as described herein.

It may now be appreciated that present principles provide for a user to quickly configure smart devices when the devices and associated controls are relevant to the user. Relevant smart devices may be determined based on location time, smart device usage history (such as when the user interacts with a particular, different smart device), etc. Based on present principles, a user may relatively easily configure the smart devices without having to, e.g., login to their device, launch a special application manually at their device, open a menu at their device, etc. Instead, configuration of the smart devices may be done from the lock screen of the user's device.

Smart devices relevant to the user may also be “learned” by the user's device based on which smart devices the user uses at certain days/times and controls from their device at certain days/times. In some embodiments, each smart device/appliance may track and store thereat the user's history of controlling it from another device and/or the user's history or control preferences for that respective smart device/appliance, while the history may also be tracked on the device the user uses to control the smart appliance and/or on another storage area at which a user's interaction with various small devices may be recorded (where, e.g., each smart device may report such data back to the storage area).

Providing a few more examples of present principles, suppose a user walks into a bedroom containing three smart lights. The user's smartphone may shows selectors for controlling the three lights in that bedroom but not smart devices in other locations, thus allowing the user to quickly dim each of the three lights, or turn them on or off. If the user moves with the smart phone to another room, the smart phone's display may be updated to show controls for other smart devices in the new location.

As another example, suppose a user walks into his or her kitchen. Since the current time of day is determined by a user's smart watch to be the user's typical dinner time, their smart watch lock screen may show smart oven and smart microwave controls for cooking since the user typically cooks on that day and/or time.

As yet another example, suppose a user walks into his or her family room. Since the user typically watches TV at that time, television controls for controlling a smart TV may be presented on the user's smartphone lock screen.

As but one more example, suppose a user is distanced away from smart devices (e.g., by more than a threshold distance) such as a web camera and smart oven that are powered on. In this example, the user being distanced from the web camera and smart oven establishes the web camera and smart oven as being relevant to the user since the user may want those devices powered off while he or she is not near them.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory and/or a signal per se.

While the particular IDENTIFICATION AND PRESENTATION OF ELEMENT AT A FIRST DEVICE TO CONTROL A SECOND DEVICE is herein shown and described in detail, it is to be understood that the subject matter which is encompassed by the present application is limited only by the claims.

What is claimed is:

1. A first device, comprising:
a processor;
a display accessible to the processor; and
storage accessible to the processor and bearing in executable by the processor to:
determine at least one element to present on the display to control a second device, the determination based at least in part on identification of at least one current relevancy parameter; and
present the at least one element on the display.

2. The first device of claim 1, wherein the at least one current relevancy parameter comprises a current time of day.

3. The first device of claim 1, wherein the at least one current relevancy parameter comprises a current day.

4. The first device of claim 1, wherein the at least one current relevancy parameter comprises a current location of the first device.

5. The first device of claim 1, wherein the at least one current relevancy parameter comprises the first device being located at least one of at a threshold distance to the second device and beyond the threshold distance to the second device.

6. The first device of claim 1, wherein the at least one current relevancy parameter comprises a current interest of a user.

7. The first device of claim 1, wherein the at least one current relevancy parameter comprises of least one item to be addressed before an event transpires.

8. The first device of claim 3, wherein the at least one current relevancy parameter is a parameter other than the second device being currently active.

9. first device of claim 1, wherein the second device is a network communication-enabled appliance.

10. The first device of claim 1, wherein the element is presented on the display without receipt of user input directed to an icon presented on the display to launch an application stored at the first device that is useable to control the second device.

11. The first device of claim 10, wherein the instructions are executable by the processor to:
launch the application in response to the determination.

11. The first device of claim 1, wherein the at least one element is selectable to adjust a setting of the second device.

13. A method, comprising:
identifying at least one selector to present on a display of a first device to control a second device based at least in part on identification of a least one criterion associated with a user being met; and
presenting the selector on the display.

14. The method of claim 13, wherein the at least one criterion comprises the user being within a predetermined area.

15. The method of claim 13, wherein the at least one criterion comprises a current time of day matching a previous time of day at which a user engaged in an activity associated with the selector.

16. A first device, comprising:
a first processor;
a network adapter; and
storage bearing instructions executable by a second processor of a second device for:
determining at least one element to present on a display to control a third device, the determining based at least in part on identification of one or more of: a current location of the second device, a current time of day, a current day, and at least one item to be addressed before an event transpires; and
presenting the at least one element on the display:
wherein the first processor transfers the instructions to the second processor over a network via the network adapter.

17. The first device of claim 16, wherein the determining is based at least in part on identification of the current location of the second device.

18. The first device of claim 16, wherein the determining is based at least in part on identification of one or more of the current time of day and the current day.

19. The first device of claim 16, wherein the determining is based at least in part on identification of the at least one item to be addressed before an event transpires.

20. The first device of claim 16, wherein the third device is a network communication-enabled appliance.
